(19) United States
(12) Patent Application Publication
(10) Pub. No.: US 2011/0091601 A1
(43) Pub. Date: Apr. 21, 2011

(54) Preparation of An Edible Product From Dough

(75) Inventors: Kim Borch, Birkerod (DK); Luise Erlandsen, Copenhagen V (DK); Morten Tovborg Jensen, Vaerlose (DK)

(73) Assignee: Novozymes A/S, Bagsvaerd (DK)

(21) Appl. No.: 12/974,492

(22) Filed: Dec. 21, 2010

Related U.S. Application Data
(63) Continuation of application No. 10/528,330, filed on Feb. 2, 2006.
(60) Provisional application No. 60/394,507, filed on Jul. 9, 2002.

(30) Foreign Application Priority Data
Jul. 3, 2002 (DK) PA 2002 01042

(51) Int. Cl. A21D 8/04

(52) U.S. Cl. 426/20; 426/61

(57) ABSTRACT

The addition of a lipoxygenase and a lipolytic enzyme active on polar lipids to a dough has a synergistic effect on the volume and/or crumb color of an edible product made by leavening and heating the dough, e.g. by baking or steaming.

### CROSS-REFERENCE TO RELATED APPLICATIONS

This application is a continuation of U.S. application Ser. No. 10/528,330 filed on Feb. 2, 2006, which is a 371 U.S. national phase application of PCT/DK03/00460 filed Jul. 2, 2003 which claims priority or the benefit under 35 U.S.C. 119 of Danish application no. PA 2002 01042 filed Jul. 3, 2002, and U.S. provisional application No. 60/394,507 filed Jul. 9, 2002, the contents of which are fully incorporated herein by reference.

### FIELD OF THE INVENTION

The present invention relates to a process for preparing an edible product by leavening and heating the dough, e.g. by baking or steaming. More particularly, it relates to such a process for preparing a product with an increased volume and/or improved crumb color (whiteness).

### BACKGROUND OF THE INVENTION

In the preparation of edible products by leavening and heating a dough, it is generally desirable to increase the volume of the product and to improve the crumb color (make the crumb whiter).

WO 9826057 and U.S. Pat. No. 4,567,046 disclose the addition of a phospholipase to dough. JP 55153549A discloses addition of a lipase and a lipoxygenase to flour. WO 9953769 and WO 2002094123 disclose the addition of enzymes to dough.

### SUMMARY OF THE INVENTION

The inventors have found that the addition of a lipoxygenase and a lipolytic enzyme active on polar lipids to a dough has a synergistic effect on the volume and/or crumb color of an edible product made by leavening and heating the dough, e.g. by baking or steaming.

Accordingly, the invention provides a process for preparing an edible product, comprising adding a lipoxygenase and a lipolytic enzyme active on polar lipids to a dough, leavening, and heating the dough, wherein the lipoxygenase and the lipolytic enzyme are added in amounts producing a synergistic effect on the volume of the edible product.

The invention also provides a composition for use in the process.

### DETAILED DESCRIPTION OF THE INVENTION

### Lipoxygenase

The lipoxygenase (EC 1.13.11.12) is an enzyme that catalyzes the oxygenation of poly-unsaturated fatty acids such as linoleic acid, linolenic acid and arachidonic acid, which contain a cis,cis-1,4-pentadiene unit and produces hydroperoxides of these fatty acids. The lipoxygenase of the invention is able to oxidize substrates containing a cis-cis-pentadienyl moiety. Thus, it may act on polyunsaturated fatty acids such as linoleic acid (18 carbon atoms, 2 double bonds), linolenic acid (18:3), arachidonic acid (20:4), eicosapentaenoic acid (EPA, 20:5) and/or docosahexaenoic acid (DHA, 22:6).

The lipoxygenase may be a 9-lipoxygenase with the ability to oxidize the double bond between carbon atoms 9 and 10 in linoleic acid and linolenic acid, or it may be a 13-lipoxygenase with the ability to oxidize the double bond between carbon atoms 12 and 13 in linoleic acid and linolenic acid.

The lipoxygenase may be from animal, plant or microbial source. A plant lipoxygenase may be from plants of the pulse family (Fabaceae), soybean (lipoxygenases 1, 2 and 3), cucumber, or barley. A microbial lipoxygenase may be from a yeast such as Saccharomyces cerevisiae, a thermophilic actinomycete such as Thermoactinomyces vulgaris or Thermomyces, e.g. T. lanuginosus, or from fungi.

A fungal lipoxygenase may be derived from Ascomycota, particularly Ascomycota incertae sedis e.g. Magnaporthaceae, such as Gaeumannomyces or Magnaporthe, or anamorphic Magnaporthaceae such as Pyricularia, or alternatively anamorphic Ascomycota such as Geotrichum, e.g. G. candidum. The fungal lipoxygenase may be from Gaeummanomyces graminis, e.g. G. graminis var. graminis, G. graminis var. avenae or G. graminis var. tritici, (WO 0220730) or Magnaporthe salvinii (PCT/DK 02/00251). Also, a fungal lipoxygenase may be from Fusarium such as F. oxysporum or F. proliferatum, or Penicillium sp.

The lipoxygenase may be used at a dosage of 0.01-10 mg of enzyme protein per kg of flour, particularly 0.1-5 mg/kg, e.g. 0.2-1 mg/kg.

### Lipolytic Enzyme Active on Polar Lipids

The invention uses a lipolytic enzyme which is capable of hydrolyzing carboxylic ester bonds in polar lipids such as phospholipids and/or galactolipids, i.e. having phospholipase and/or galactolipase activity. Thus, the lipolytic enzyme may have phospholipase A1 or A2 activity (EC 3.1.1.32 or 3.1.1.4), i.e. hydrolytic activity towards one or both carboxylic ester bonds in phospholipids such as lecithin. Further, the lipolytic enzyme may have galactolipase activity (EC 3.1.1.26), i.e. hydrolytic activity on carboxylic ester bonds in galactolipids such as DGDG (digalactosyl diglyceride).

The lipolytic enzyme may or may not have lipase activity (activity on triglycerides, EC 3.1.1.3). It may have a higher activity on polar lipids than on triglycerides.

The lipolytic enzyme may be of animal origin, e.g. from pancreas, snake venom or bee venom, or it may be of microbial origin, e.g. from filamentous fungi, yeast or bacteria, such as Aspergillus or Fusarium, e.g. A. niger, A. oryzae or F. oxysporum, e.g. the enzymes described in WO 9826057, WO 0200852. Also, the variants described in WO 0032758 may be used, e.g. a variant of Thermomyces lanuginosus lipase having phospholipase and/or galactolipase activity.

The lipolytic enzyme may be used at a dosage of 0.01-10 mg of enzyme protein per kg of flour, particularly 0.1-5 mg/kg, e.g. 0.2-1 mg/kg.

### Synergistic Effect

The combination of the lipoxygenase and the lipolytic enzyme has a synergistic effect on volume and/or crumb color of an edible product made by leavening and heating the dough.

Synergy may be determined by making doughs or baked products with addition of the two enzymes separately and in combination, and comparing the effects; synergy is indicated when the combination produces a better effect than each enzyme used separately.

The comparison may be made between the combination and each enzyme alone at double dosage (on the basis of enzyme protein or enzyme activity). Thus, synergy may be said to occur if the effect of 0.5 mg of enzyme A+1.0 mg of enzyme B is greater than the effect with 1.0 mg of enzyme A and also greater than the effect with 2.0 mg of enzyme B.

Alternatively, the comparison may be made with equal total enzyme dosages (as pure enzyme protein). If the effect with the combination is greater than with either enzyme alone, this may be taken as an indication of synergy. As an example, synergy may be said to occur if the effect of 0.5 mg of enzyme A+1.0 mg of enzyme B is greater than with 1.5 mg of enzyme A or B alone.

### Dough

The dough is leavened e.g. by adding chemical leavening agents or yeast, usually Saccharomyces cerevisiae (baker's yeast).

The dough generally comprises wheat meal or wheat flour and/or other types of meal, flour or starch such as corn flour, corn starch, rye meal, rye flour, oat flour, oat meal, sorghum meal, sorghum flour, rice flour, potato meal, potato flour or potato starch.

The dough may be fresh, frozen or par-baked.

The dough may be a laminated dough.

The dough may also comprise other conventional dough ingredients, e.g.: proteins, such as milk powder and gluten; eggs (either whole eggs, egg yolks or egg whites); an oxidant such as ascorbic acid, potassium bromate, potassium iodate, azodicarbonamide (ADA) or ammonium persulfate; an amino acid such as L-cysteine; a sugar; a salt such as sodium chloride, calcium acetate, sodium sulfate or calcium sulfate. The dough may comprise fat (triglyceride) such as granulated fat or shortening.

The dough may further comprise an emulsifier such as mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, or lysolecithin.

### Edible Product

The process of the invention is used for preparing a an edible product by leavening and heating a dough, e.g. by baking or steaming. The product may be of a soft or a crisp character, either of a white, light or dark type. Examples are steamed or baked bread bread (in particular white, whole-meal or rye bread), typically in the form of loaves or rolls, French baguette-type bread, pita bread, tortillas, cakes, pancakes, biscuits, cookies, pie crusts, crisp bread, steamed bread, pizza and the like.

### Enzyme Composition

The invention provides a composition (e.g. a baking composition) comprising a lipoxygenase, a phospholipase and optionally an additional enzyme as described below.

The composition may be an enzyme preparation, e.g. in the form of a granulate or agglomerated powder. It may have a narrow particle size distribution with more than 95% (by weight) of the particles in the range from 25 to 500 μm. Granulates and agglomerated powders may be prepared by conventional methods, e.g. by spraying the amylase onto a carrier in a fluid-bed granulator. The carrier may consist of particulate cores having a suitable particle size. The carrier may be soluble or insoluble, e.g. a salt (such as NaCl or sodium sulfate), a sugar (such as sucrose or lactose), a sugar alcohol (such as sorbitol), starch, rice, corn grits, or soy.

The composition may, in addition to enzymes, comprise other baking ingredients, particularly flour. Thus, the composition may be a dough or a flour pre-mix.

### Additional Enzyme

Optionally, an additional enzyme may be used together with the lipoxygenase and the lipolytic enzyme.

The additional enzyme may be an amylase, a cyclodextrin glucanotransferase, a protease or peptidase, in particular an exopeptidase, a transglutaminase, a lipase, a phospholipase, a cellulase, a hemicellulase, a glycosyltransferase, a branching enzyme (1,4-α-glucan branching enzyme) or a second oxidoreductase. The additional enzyme may be of any origin, including mammalian and plant, and preferably of microbial (bacterial, yeast or fungal) origin.

The amylase may be from a fungus, bacterium or plant. It may be a maltogenic alphaamylase (EC 3.2.1.133), e.g. from B. stearothermophilus, an alpha-amylase, e.g. from Bacillus, particularly B. licheniformis or B. amyloliquefaciens, a beta-amylase, e.g. from plant (e.g. soy bean) or from microbial sources (e.g. Bacillus), a glucoamylase, e.g. from A. niger, or a fungal alpha-amylase, e.g. from A. oryzae.

The hemicellulase may be a pentosanase, e.g. a xylanase which may be of microbial origin, e.g. derived from a bacterium or fungus, such as a strain of Aspergillus, in particular of A. aculeatus, A. niger, A. awamori, or A. tubigensis, from a strain of Trichoderma, e.g. T. reesei, or from a strain of Humicola, e.g. H. insolens.

The protease may be from Bacillus, e.g. B. amyloliquefaciens.

The second oxidoreductase may be a glucose oxidase, a hexose oxidase, a peroxidase, or a laccase.

### EXAMPLES

### Example 1

1 kg flour doughs were prepared by a straight dough procedure with addition of phospholipase from F. oxysporum and lipoxygenase (LOX) from M. salvinii as shown in the table below. The LU activity unit is defined in WO 0032758.

The doughs were leavened and baked, and the specific volume and crumb properties were evaluated for bread baked from each dough. Crumb properties were evaluated by a panel using a scale from 0 to 10 taking the control as 5, as follows:

Uniform: 0=uneven, 10=very uniform

Grain: 0=open, 10=fine

Cell wall: 0=thick, 10=thin

Cell form: 0=round, 10=elongate

Crumb color: 0=dark, 10=white

| | Invention | Control | Reference | | |
|---|---|---|---|---|---|
| Phospholipase, LU/kg | 500 | | 500 | | |
| LOX, mg/kg | 0.2 | | | 0.2 | |
| Soy flour, % by | | | | | 0.5 |
| weight | | | | | |
| Sp. Vol. (ml/g) | 5.06 | 4.31 | 4.78 | 4.45 | 4.36 |
| Sp. Vol. (%) | 117 | 100 | 111 | 103 | 101 |
| Crumb evaluation | | | | | |
| (Ext. proof) | | | | | |
| Uniform | 7 | 5 | 7 | 3 | 4 |
| Grain | 7 | 5 | 7 | 2 | 4 |
| Cell Wall | 7 | 5 | 7 | 4 | 4 |
| Cell Form | 7 | 5 | 7 | 2 | 6 |
| Crumb Color | 7 | 5 | 6 | 6 | 8 |

The results show that soy flour has no impact on volume, but the crumb color (whiteness) is improved by soy flour.

LOX alone has no impact on volume, and the crumb color is slightly improved compared to the control.

The phospholipase alone gives clear volume and crumb structure improvements LOX in combination with the lipase has a synergistic effect on volume, and crumb color is also improved compared to the phospholipase or LOX alone.

1. A process for preparing an edible product, comprising adding a lipoxygenase and a lipolytic enzyme active on polar lipids to a dough, leavening, and heating the dough, wherein the lipoxygenase and the lipolytic enzyme are added in amounts producing a synergistic effect on the volume of the edible product.

2. A process of preparing a baked product comprising:
a) adding to a dough a lipoxygenase and a lipolytic enzyme active on polar lipids, and
b) baking the dough,
wherein the lipoxygenase and the lipolytic enzyme are added in amounts producing a synergistic effect on the volume or the crumb color of the baked product.

3. A composition comprising: a lipoxygenase and a lipolytic enzyme active on polar lipids wherein the lipoxygenase and the lipolytic enzyme are added in amounts producing a synergistic effect on the volume or the crumb color of the baked product.

4. The composition of the preceding claim which further comprises flour.

5. The composition of the preceding claim which is a dough, a flour composition, or a flour pre-mix.

6. A method of increasing the volume or the crumb color of a baked product comprising:
a) adding to a dough a lipoxygenase and a lipolytic enzyme which is active on polar lipids and on triglycerides,
b) baking the dough to prepare a baked product, and
c) measuring the volume or the crumb color of the baked product.
